(19) United States
(12) Patent Application Publication
(10) Pub. No.: US 2025/0086094 A1
(43) Pub. Date: Mar. 13, 2025

(54) The use of artificial intelligence in a static analysis of software quality

(71) Applicant: Tomasz Korzeniowski, Warsaw (PL)

(72) Inventor: Tomasz Korzeniowski, Warsaw (PL)

(21) Appl. No.: 18/243,721

(22) Filed: Sep. 8, 2023

(51) Int. Cl. G06F 11/36

(52) U.S. Cl. CPC G06F 11/3624

(57) ABSTRACT

A software development tool for automated code review, analysis, and monitoring is disclosed. The platform integrates with version control systems to automatically analyze code for various metrics, including code complexity, duplication, maintainability, and test coverage. The tool provides insights and feedback to developers to improve code quality, reduce technical debt, and prevent software bugs. The tool also offers integration with popular messaging services to send notifications, reports, and alerts. The tool is highly scalable, secure, and customizable, making it suitable for large and small development teams.

### BACKGROUND OF THE INVENTION

The invention pertains to the field of software quality analysis, specifically the use of artificial intelligence in static code analysis. This falls under U.S. patent classification 717/124, which covers software development tools and techniques for improving software quality, including means or steps for testing program code for the purpose of determining correctness and performance of software or for locating and correcting errors under software development.

There are two main types of existing code quality tools which are this tool direct competitors—sophisticated and expensive on—premises tools for enterprise and rudimentary SaaS products for smaller engineering organizations.

Existing SaaS code quality platforms all take the same path in building their product—they look for open-source code analysis software, bundle it into one package and offer it in a hosted version with a user-friendly interface and workflow integrations as value-added. Code Climate, Codacy, and Scrutinizer are all examples of this exact approach. Availability, quality, and extensibility of the underlying open-source software are three major issues for this class of products. Each software quality library has a different set of checks, and even two extremely similar languages (e.g., Ruby and Python) see our competitors report on entirely different issues. Our tool takes a radically different path—with all algorithms developed in-house and our language-agnostic analysis technology, we can offer the same set of checks for all languages supported.

When adding support for a new language, our tool offers the same package as we provide for all other languages, and when adding a new element to this package, we add it for all supported languages. This approach allows us to be the first solution in many markets—Swift and Objective-C for iOS development, Kotlin for Android development, or (soon) Elixir and TypeScript for web development. Having full control over our stack also means that while our SaaS competitors are currently at or near the peak of their capabilities, we are only starting to explore possibilities.

There is a second class of software quality tools aiming at the enterprise market. Like our tool, these tools are based on proprietary technology rather than open-source libraries, giving them full control over their stack. Products from this category are primarily installed on-premises and require a lot of upfront investment and setup as well as expensive ongoing maintenance. Such solutions are inflexible with support for new technologies unavailable or prohibitively costly to introduce. In today's dynamic environment, organizations are looking for more flexible and adaptable solutions, both regarding capability and pricing. On-premises installation of our tool with support for all or nearly all programming languages used by an enterprise can offer an attractive alternative to existing solutions.

### SUMMARY OF THE INVENTION

A software tool that uses artificial intelligence to analyze the quality of code in various programming languages. It provides a unified set of quality checks that can be applied consistently across an organization's entire codebase, allowing for the identification of areas where issues are most likely to arise. By automating code review, the tool complements human review processes and frees up developers to focus on higher-level problems like business logic and application architecture. This invention addresses the growing demand for high-quality software in today's world and offers a competitive solution for organizations looking to improve their software development practices.

### DETAILED DESCRIPTION OF THE INVENTION

Software tool uses static analysis to understand the structure of code.

The two initial steps of this process are as follows: firstly, the code is broken into pieces, some of which (keywords) have special meaning for the programming language. This stage is performed by a program called a lexer. Next, the sliced code is passed into another program called a parser, which understands the syntax of the programming language and converts a stream of tokens into a tree-like data structure known as an Abstract Syntax Tree.

The tool examines the structure of the code and can calculate code quality metrics for a project, without the need for compiling or executing the code. Although the tool is based on a substantial body of academic and practical work in the field of static code analysis, it does not rely on any existing libraries. Instead, it utilizes algorithms to prioritize correctness, extensibility, and performance.

After the algorithms complete their execution and generate a project report, the tool analyzes both current and historical data to achieve the following:
a. Identify the most significant issues in the analyzed codebase.
b. Create annotated diffs for edits that cause significant code quality changes, diffs are tools that compare and display the differences between file contents.
c. Establish a connection between the current state and historical data to assist in resolving quality problems.

The project report includes a numerical value ranging from 0 (worst) to 4 (best). Generally, higher scores are more desirable.

For every namespace detected in the project, the algorithms calculate a distinct score by applying various penalties for different violations and deducting them from a perfect score of 4.0. Some violations are detected at the function level, while others can only be reported at the namespace level. Penalties related to function-level violations are normalized by the total number of functions in a namespace, resulting in a relatively lower impact on the overall score.

Namespace-level penalties are applied after normalization, making them more significant. These penalties encompass factors such as high total complexity, a large number of functions in a namespace, and code duplication. In the case of code duplication, the tool arbitrarily but deterministically decides which copy is considered the original and which is a copy-paste, applying a penalty only to the namespace associated with the latter.

After the scores for each namespace have been individually calculated, the tool computes a weighted arithmetic mean, where the weight of each namespace is determined by its function count.

For every supported language, the tool can calculate a universal set of metrics directly related to software quality, extensibility and maintainability.

Assignment Branch Condition is a synthetic metric which helps us understand the size of the source code from a structural point of view without looking at superficial things like the amount of code. It is computed by counting the number of assignments, branches and conditions for a given section of code. These are defined in following paragraphs:

Assignment: an explicit transfer of data into a variable, e.g. =, *=, /=, %=, +=, <<=, >>=, &=, |=, \hat{ }=, >>>=, ++, −− etc.;

Branch: an explicit forward program branch out of scope, e.g. a function call, class method call, or new operator etc.;

Condition: a logical/Boolean test, e.g. ==, !=, <=, >=, <, >, else, case, default, try, catch, ?, unary conditionals etc.;

A scalar ABC size value (or aggregate magnitude) is computed as:

$$\vert ABC \vert = sqrt ( ( A * A ) + ( B * B ) + ( C * C ) )$$

While not intended as a code complexity measure, we can use ABC as an indicator of how much actual work a piece of code is performing. Good design would have developers prefer shorter procedures that are more readily understood, more reusable and more testable than their longer counterparts. Functions and methods with high ABC scores often indicate a lack of up-front design and a certain disregard of code testability and maintainability.

Defaults: the tool allows the ABC size to be up to 10 with no penalty, 10-20 will trigger an INFO-level issue, 20-40 will trigger a WARNING, 40-60—an ERROR and anything above that will lead to a CRITICAL issue. The default setting is thus [10, 20, 40, 60]. This default is relaxed to [15, 25, 50, 70] for Objective-C which is a less terse language.

Cyclomatic complexity of a section of source code is the number of linearly independent paths within it. For instance, if the source code contained no control flow statements (conditionals or decision points), such as if statements, the complexity would be 1, since there is only a single path through the code. If the code had one single-condition if statement, there would be two paths through the code: one where the if statement evaluates to true and another one where it evaluates to false, so complexity would be 2 for a single if statement with a single condition. Two nested single-condition ifs, or one if with two conditions, would produce a cyclomatic complexity of 4.

Cyclomatic complexity is instrumental in figuring out how easy it is to test the code. A function with cyclomatic complexity of 2 will generally require 5 times fewer test cases than a function with a score of 10. High scores also indicate code that is difficult for humans to comprehend, as understanding a single statement will require the developer to keep a large stack of ‘how I even got here’ data in their short-term memory.

Defaults: the tool allows the cyclomatic complexity to be up to 10 with no penalty, 10-20 will trigger an INFO-level issue, 20-35 will trigger a WARNING, 35-50—an ERROR and anything above that will lead to a CRITICAL issue. The default setting is thus [10, 20, 35, 50].

Lines of code refers to non-commentary lines, meaning pure whitespace and lines containing only comments are not included in the metric. It is the most naive and rudimentary code size metric out there and so deserves less attention than more insightful metrics described above. Long functions that do a lot of work will often be penalized for both high Assignment Branch Condition size and too many lines of code. However, there may be cases where an increased number of lines of code increases readability and maintainability.

Defaults: the tool allows the number of lines of code per function to be up to 24 with no penalty, 25-39 will trigger an INFO-level issue, 40-60 will trigger a WARNING, 60-80—an ERROR and anything above that will lead to a CRITICAL issue. The default setting is thus [25, 40, 60, 80]. This default is much more strict ([10, 20, 40, 80]) in Ruby where short functions are a strong community standard. On the other hand, Java is a much more verbose language and the default is more lenient at [30, 45, 70, 100].

Arity represents a number of arguments that a function takes. Functions with longer lists of parameters are more difficult to use and more cumbersome to test.

Defaults: the tool allows 3 or fewer parameters with no penalty, 4 will trigger an INFO-level issue, 5 will trigger a WARNING, 6—an ERROR and anything above that will lead to a CRITICAL issue. The default setting is thus [4, 5, 6, 7]. This default is more relaxed ([5, 6, 7, 8]) for Python where instance methods need the receiver (usually called self) to be passed as their first argument.

Number of return values in Go language. Go is special in that it allows a single function to return multiple values. This is often used to pass errors in addition to regular return values in absence of more traditional exception handling. However, this clever pattern can be abused by functions returning long lists of values that are hard to understand and hard for the callers to handle.

Defaults: the tool allows 3 or fewer return values with no penalty, 4 will trigger an INFO-level issue, 5 will trigger a WARNING, 6—an ERROR and anything above that will lead to a CRITICAL issue. The default setting is thus [4, 5, 6, 7].

Maximum block nesting calculates how deeply nested the deepest statement in a single function is. If you're using consistent indentation, you can visualize this as the most right-indented line of the function's body. Deep nesting shows a complicated design with too much control flow (in case of if/else nesting), computational complexity (in case of nested for loops) or a combination of both.

Defaults: 3 levels of nesting will carry an INFO level issue, 4—a WARNING level issue, 5—an ERROR and 6 and more will trigger a CRITICAL issue. The default setting is thus [3, 4, 5, 6].

Code duplication: The DRY (Don't Repeat Yourself) Principle states that every piece of knowledge must have a single, unambiguous, authoritative representation within a system. Our analyzers can detect code duplication through the analysis of code structure, both within and between source files. We can also find very similar code which we treat the same as straight copy-paste jobs. Duplication (inadvertent or purposeful) points to wasted effort, poor design mindset, inability to see and factor out the patterns within the codebase and a general disregard for good coding practices. It can and will lead to maintenance nightmares whereby changes to duplicated code need to be copied over to all of its instances and missing a single instance may be a source of a serious bug. We consider code duplication an even more serious issue than the ones described above and the tool will penalize it more heavily than any of those per-function violations.

Defaults: This setting is not customizable and each language has a different set of defaults based on the look of its' parse tree.

On top of complexity metrics for individual functions, the tool also looks at some aggregate metrics on the namespace level. This article describes each of these along with the rationale why we believe it to be important. Note that for Go all of these are only calculated for struct receivers, in Swift for classes, structs and enums, in Objective-C for implementations and in Python for classes.

Total complexity represents aggregate Assignment Branch Condition size of the entire namespace. High total complexity indicates a namespace that contains too much logic and should probably be broken down into smaller elements. It can also indicate that the few existing functions are each too busy and they need to be individually refactored. One way or another being dinged for total complexity is a signal that some thought should be put into higher-level refactoring of the namespace.

Defaults: the tool allows the total complexity score to be up to 75 with no penalty, 75-150 will trigger an INFO-level issue, 150-250 will trigger a WARNING, 250-350—an ERROR and anything above that will lead to a CRITICAL issue. The default setting is thus [75, 150, 250, 350].

The default setting is somewhat more relaxed ([100, 180, 280, 400]) for Objective-C which is a less terse language.

Lines of code represents the total length (code-wise) of a namespace. It is probably the most naive metric among the ones that we report on but can nevertheless provide substantial value. Ideally a single logical unit of code (class, module, etc.) should fit on one screen, without the need for scrolling. Longer namespaces are harder to navigate and understand, making your code less maintainable.

Defaults: the tool allows the total size of a namespace to be up to 150 lines of code with no penalty, 150-200 will trigger an INFO-level issue, 200-300 will trigger a WARNING, 300-400—an ERROR and anything above that will lead to a CRITICAL issue. The default setting is thus [150, 200, 300, 400].

Defaults: This default setting is more strict ([100, 140, 200, 350]) for Ruby where the community strongly encourages small classes and less strict for Objective-C and Java ([180, 240, 320, 420] and [200, 250, 320, 450] respectively) where method definitions and calls often span multiple lines.

Number of functions is another high-level complexity metric. It is designed to encourage smart composition and modularity instead of refactoring code by multiplying private methods. We believe that a namespace with more than 15 (private and public) functions is a good candidate for breaking up into multiple independent modules each with its own set of data.

Defaults: the tool allows up to 14 functions with no penalty, 15-19 will trigger an INFO-level issue, 20-29 will trigger a WARNING, 30-50—an ERROR and anything above that will lead to a CRITICAL issue. The default setting is thus [15, 20, 30, 50].

Number of instance variables is a metric designed to detect classes that carry too much state. Since every instance variable has an impact on the overall status of the object the more instance variables you have the more possible states your object can have and this number grows exponentially as you keep adding instance variables. It is up to the programmer to ensure that they understand all possible combinations of different values of instance variables in order to avoid unexpected behavior. Too many instance variables will quickly lead to an untestable, unmaintainable class.

Defaults: the tool allows up to 4 instance variables with no penalty, 5 will trigger an INFO-level issue, 6 and 7 will trigger a WARNING, 8-10—an ERROR and anything above that will lead to a CRITICAL issue. The default setting is thus [5, 6, 8, 11].

1. A code analysis tool comprising: a set of code quality metrics; a method for analyzing said metrics to improve the code; a reporting system that identifies the best approach for enhancing the code quality based on said analysis.

2. A code analysis tool as in claim 1, wherein said method for analyzing is comprised of the same set of checks for all languages supported in said tool.
